(19) United States
(12) Patent Application Publication
(10) Pub. No.: US 2010/0116697 A1
(43) Pub. Date: May 13, 2010

(54) PORTABLE METAL DOCUMENT CONTAINER WITH ORGANIZER MODULES

(76) Inventor: ROSA MATA GONAZLEZ, LA PALMA, CA (US)

Correspondence Address: Patent Law Agency, LLC;PETER GANJIAN, 3146 North Verdugo Road, Glendale, CA, 91208-1665, US

(21) Appl. No.: 12/615,246

(22) Filed: Nov. 9, 2009

Related U.S. Application Data
(60) Provisional application No. 61/198,804, filed on Nov. 10, 2008.

(51) Int. Cl. B65D 85/00; B42D 17/00

(52) U.S. Cl. 206/216; 281/45; 220/500

(57) ABSTRACT

A portable metal document container comprising a cover with a first organizer module coupled with the interior surface of the cover. The portable metal document container further includes an intermediate member that includes a set of apertures through which is inserted a document fastener, with a plurality of labeled end-tab document dividers securely held on a first side of the intermediate member by the document fastener. The portable metal document container also includes a second organizer module coupled with a second side of the intermediate member, and one or more magnetic strips coupled with an interior back surface of the portable metal document container for organizing metal objects.

### CROSS-REFERENCE TO RELATED APPLICATIONS

This Application claims the benefit of priority of the co-pending U.S. Utility Provisional Patent Application No. 61/198,804, filed Nov. 10, 2008, the entire disclosure of which is expressly incorporated by reference in its entirety herein.

### BACKGROUND OF THE INVENTION

1. Field of the Invention

This invention relates to a portable metal document container and, in particular, to a portable metal document container with organizer modules for organizing items required by professional personal.

2. Description of Related Art

Most professional personal (e.g., law enforcement, paramedics, or any others that work outside the “office”) use a portable metal document container with flat, smooth exterior and interior surfaces to carry required work items. In general, most portable metal document containers are comprised of a rectangular metal box with a metal cover or enclosure (and with or without an intermediate member that separates the box chamber into two compartments).

Today, the day-to-day function of a professional personal (e.g., law enforcement personal) requires the use of a plethora of different forms from writing citations to filling out a plurality of reports for crime scenes, and so on. These forms, along with other items such as pupil-A-meters, stencil traffic graphs, evidence envelopes, and other items as simple as paper clips must be carried by professional personal. Evidence envelopes are used by law enforcement personal to store evidence found in the “field” (e.g., a crime scene, including drugs, bullets, etc.).

Regrettably, conventional portable metal document containers do not have the means to organize and store items (e.g., forms, cards, envelopes, paper clips, etc.). For example, most law enforcement personal store the evidence envelopes or other required items in the trunk of their patrol cars. The conventional portable metal document containers have no means and in fact, were never intended to provide a mechanism to organizing forms or other items required for the daily function of a professional personal, and were only intended as a strong, sturdy, metal storage box to protect and only carry some forms or other items literally dumped therein the portable metal document container. The use of metal in the portable metal document container is important in that it protects documents inside the container from outside elements. On the other hand, the use of metal with smooth metal surfaces does not permit for addition of organizing mechanisms to organize forms or other items. Therefore, all forms and most other items required by the professional personal are simply “dumped” into the conventional portable metal document containers and carried around in patrol. When a form or an item as simple as a paper clip is needed (e.g., a form to generate a particular report), the professional personal must literally “dig” through the container to find the right form or the simple paper clip. It should be noted that there are well over 200 different types of forms used for different reports in the field of law enforcement. For example, in the law enforcement field, citations of persons driving or operating a vehicle while under influence (known as “DUI”) require completion of a particular set of forms and reporting of an assault requires yet other different set of forms. Finding the right form inside the conventional portable metal document container to generate a correct report is obviously time consuming and certainly not efficient because there is no means of organizing any of those 200 plus forms. In addition, the messy, clutter of mixed up forms in the conventional containers exposes the law enforcement personal to unnecessary risk if they require access to an item or a form on the side of a road with high vehicular traffic or if the law enforcement personal are in the middle of a chaotic crime scene still in progress. That is, instead of concentrating on a crime still in progress or their safety along a side of a road, they have to divert their attention to “digging” through the numerous forms or the items inside the conventional portable metal document containers to pull out the right form to perform their function. This can truly be a life-threatening situation. Again, the conventional containers are nothing more than a smooth, flat metal box, literally.

In order to compensate for the inefficiencies due to lack of organizational ability, and quickly process a citation or a crime scene and generate the correct report while a victim or the public waits, most law enforcement officials have switched to using cards or slip notes that include a report and a file number, that references or “point to” a corresponding report(s). The use of such cards requires the public to pick up the actual report at a later time from a law enforcement station, which is inconvenient. The problem with the use of cards or slip notes is that there are many different types of cards or slip notes for different reports. The cards or slip notes reduce the time for processing a citation for example, but the time to finding the right card or slip note to generate or reference the correct report is still time consuming because the conventional portable metal document containers do not have any means to properly store and organize the various different cards or notes used. Accordingly, instead of having messy, mixed up forms in the conventional boxes, there is now messy, mixed up forms and cards. As indicated above, a conventional portable metal document container is just a smooth, flat metal box. Therefore, the same problems associated with the forms or items also plague the use of plurality of cards or notes used for referencing different reports, and in fact, it is compounded.

Accordingly, in light of the current state of the art and the drawbacks to current portable metal document container mentioned above, a need exists for a container that has the means to organize and store items, while substantially maintaining the protective characteristics of the conventional portable metal document container.

### BRIEF SUMMARY OF THE INVENTION

One exemplary aspect of the present invention provides a portable metal document container, comprising:
a first organizer module that is a soft, flexible organizer pocket coupled with an interior of the portable metal document container.

One exemplary optional aspect of the present invention provides a portable metal document container, wherein:
the first organizer module is coupled with an interior surface of a cover of the portable metal container.

Another exemplary optional aspect of the present invention provides a portable metal document container, further including:
one or more magnetic strips for organizing metal objects coupled with the interior of the portable metal document container.

A further exemplary optional aspect of the present invention provides a portable metal document container, wherein:
the one or more magnetic strips are coupled with an interior back surface of a backside of the portable metal document container.

Still a further exemplary optional aspect of the present invention provides a portable metal document container, further including:
a set of apertures through which is inserted a document fastener;
a plurality of labeled end-tab document dividers that are securely held within the interior of the portable metal document container by the document fastener, with plurality of different documents organized in between the labeled end-tab documents dividers for quick and convenient access.

Another exemplary optional aspect of the present invention provides a portable metal document container, further including:
an intermediate member having a first side and a second side;
the intermediate member divides an interior chamber of the portable metal document container into a first and second compartments;
the first compartment is comprised of the interior surface of the cover and the first side of the intermediate member, and the second compartment is comprised of the second side of the intermediate member and a backside of the portable metal document container;
the intermediate member includes a set of apertures through which is inserted a document fastener;
a plurality of labeled end-tab document dividers are securely held on the first side of the intermediate member by the document fastener, with plurality of different documents organized in between the labeled end-tab documents dividers for quick and convenient access; and
a second organizer module is a soft, flexible organizer pocket coupled with the second side of the intermediate member.

A further exemplary aspect of the present invention provides a portable metal document container, comprising:
a cover having an exterior and an interior surface;
a first organizer module is a soft, flexible organizer pocket coupled with the interior surface of the cover;
an intermediate member having a first side and a second side;
the intermediate member divides an interior chamber of the posse box into a first and second compartments;
the first compartment is comprised of the interior surface of the cover and the first side of the intermediate member, and the second compartment is comprised of the second side of the intermediate member and a backside of the portable metal document container;
the intermediate member includes a set of apertures through which is inserted a document fastener;
a plurality of labeled end-tab document dividers are securely held on the first side of the intermediate member by the document fastener, with plurality of different documents organized in between the labeled end-tab documents dividers for quick and convenient access;
a second organizer module is a soft, flexible organizer pocket coupled with the second side of the intermediate member; and
an interior back surface of the backside of the posse box includes one or more magnetic strips for organizing metal objects.

Another exemplary optional aspect of the present invention provides a portable metal document container, wherein:
the first organizer module includes:
an elastic band for securing a notepad;
a pouch, and
a side storage with a slit opening.

A further exemplary optional aspect of the present invention provides a portable metal document container, wherein:
the first side of the intermediate member is comprised of raised edges around a periphery of the first side, defining a tray structure with a base having a flat, smooth metal surface.

Another exemplary optional aspect of the present invention provides a portable metal document container, wherein:
the set of apertures are positioned along a width, at a first center end of the intermediate member.

A further exemplary optional aspect of the present invention provides a portable metal document container, wherein:
the document fastener has a set of prongs that are inserted through the apertures.

Still a further exemplary optional aspect of the present invention provides a portable metal document container, wherein:
the second organizer module includes:
an elastic band for securing a notepad;
a large pocket for retaining booklets, and
a plurality of smaller pockets for retaining various cards.

Another exemplary optional aspect of the present invention provides a portable metal document container, wherein:
a coupler is used to couple:
the first organizer module with the interior surface of the cover;
the second organizer module with the second side of the intermediate member; and
the magnetic strip with the interior back surface of the backside;

A further exemplary optional aspect of the present invention provides a portable metal document container, wherein:
the coupler is a double sided adhesive.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is an exemplary perspective illustration of a closed portable metal document container in accordance with the present invention;

FIG. 2 is an exemplary perspective illustration of the portable metal document container shown in FIG. 1, but in a semi-open position in accordance with the present invention;

FIG. 3 is an exemplary perspective illustration of couplers in accordance with the present invention;

FIG. 4 is an exemplary perspective illustration of a first and a second compartments of the portable metal document container in accordance with the present invention; and

FIG. 5 is an exemplary perspective illustration of a second compartment of the portable metal document container in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For the sake of convenience and clarity only, this disclosure refers throughout to exemplary rectangular portable metal document containers that have a hinge mechanism oriented parallel along a length of the portable metal document container, and further include an intermediate member. However, the present invention is also applicable to any shaped portable metal document container with hinge mechanism (if any) positioned along any appropriate side, with or without an intermediate member. For example, the present invention is very much applicable to rectangular portable metal document containers with hinge mechanism positioned along the width of the portable metal document containers (with a cover that may open similar to a bank deposit box), with or without the intermediate member. Accordingly, all references to a rectangular portable metal document container with a hinge mechanism on the length side and an intermediate member therein shown and described throughout the disclosure are only meant as illustrative and only for convenience of example, and therefore, should not be limiting.

In general, the present invention provides a portable metal document container that includes a cover having an exterior that may include a clip that enables the metal cover or enclosure to function as a clipboard. The cover of the portable metal document container of the present invention includes an interior surface with a first organizer module coupled therewith. An intermediate member of the portable metal document container of the present invention has a first side that includes a set of apertures through which are inserted a commensurate set of prongs of a file-folder fastener for securing a plurality of labeled end-tab document dividers for organizing and utilizing desired documents. A second side of the intermediate member of the portable metal document container of the present invention is comprised of a second organizer module coupled therewith, which may be different from the first organizing module. An interior surface of a back of the portable metal document container of the present invention forms a second compartment with inner walls having one or more magnetic strips to retain metallic items such as clips and paper clip.

More specifically, the interior surface of the cover faces a first side of the intermediate member (or divider), forming a first compartment having a first volume. The first side of the intermediate member has raised edges around its periphery, defining a tray like structure that forms the first compartment. Both the interior of the cover and the first side of the intermediate member are comprised of flat, smooth metal surfaces, and are coupled to the portable metal document container by a hinge mechanism. A second side of the intermediate member (or divider) faces the interior of the backside of the portable metal document container, forming a second compartment having a second volume. That is, the second side of the intermediate member faces the second compartment (or the main, larger storage compartment of the portable metal document container). The second compartment has raised edges around its periphery (similar to a deep rectangular box), defining the second compartment volume, which is greater than the first compartment volume. The second side of the intermediate member and the interior of the second compartment are comprised of flat, smooth metal surfaces. Accordingly, the cover encloses the top of the first compartment and the intermediate member encloses the top of the second compartment. As stated above, other portable metal document container exist where container includes only a single chamber with a clipboard cover (all metal), that is hinged along the width of the portable metal document container, which may open similar to a bank deposit box.

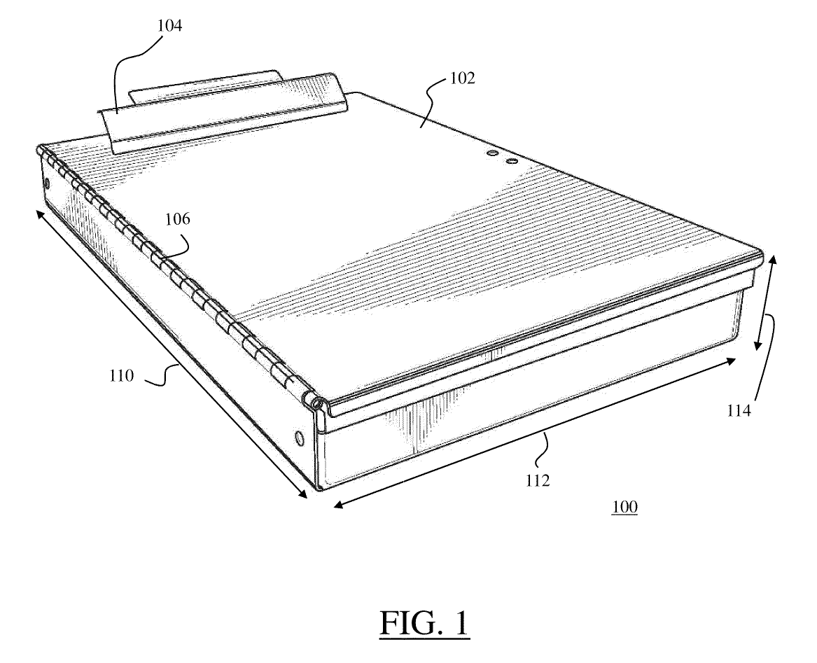

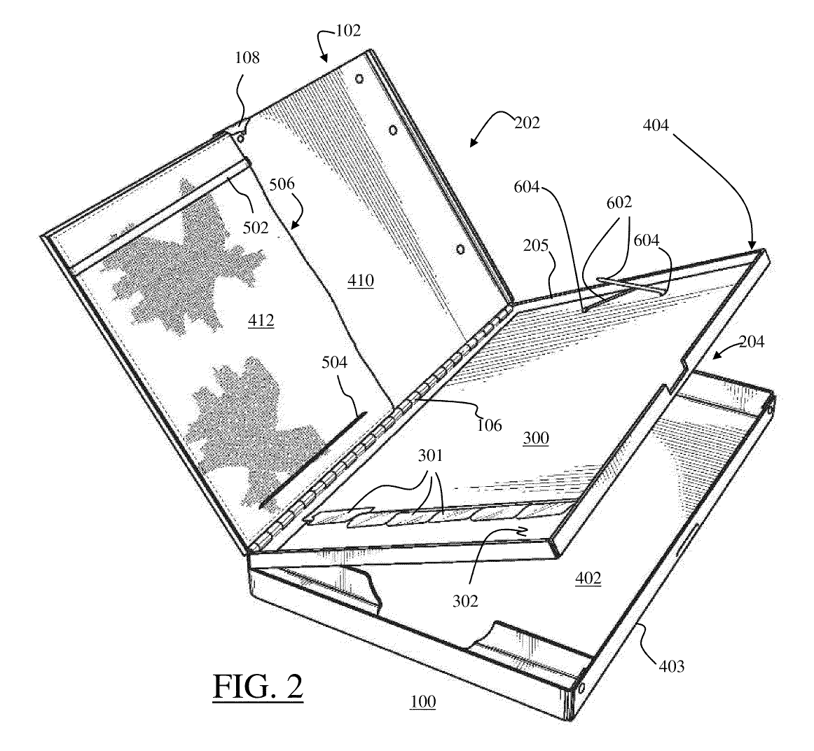

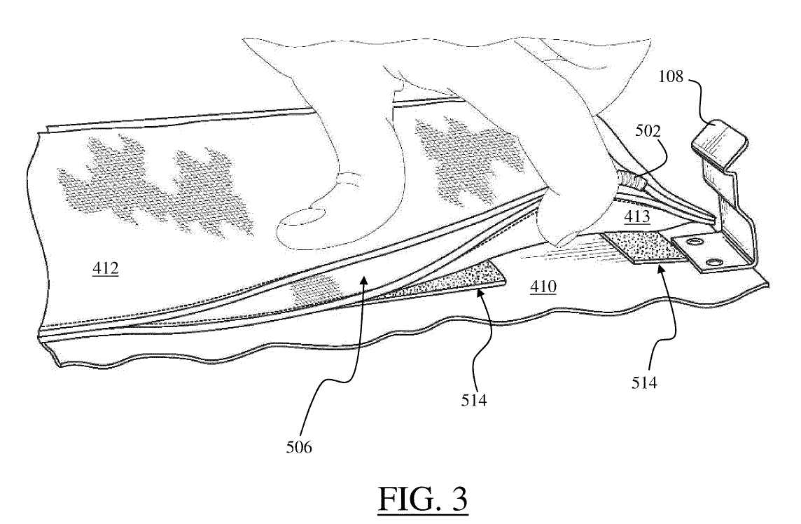

As best illustrated in FIG. 1, in general, the portable metal document container 100 of the present invention is a substantially rectangular metal box having an axial length 110, a width 112, and a depth of 114. The portable metal document container 100 is painted with polymer or resin to protect the metal from outside elements and rusting. The portable metal document container 100 of the present invention is comprised of a metal cover or enclosure 102 that includes an optional clip 104, which enables the metal cover or enclosure 102 to function as a clipboard. The metal cover or enclosure 102 is coupled to the body of the portable metal document container 100 by a hinge 106, and functions as the “door” to a first compartment, and locks by a lock mechanism 108 (FIGS. 2 to 5).

As illustrated in FIG. 2, the portable metal document container 100 of the present invention includes a first compartment 202 and a lower, second compartment 204. An intermediate member 404 divides the respective first and second compartments 202 and 204. The respective first and second compartments 202 and 204 of the present invention are especially designed to hold a form pad, a writing pad, a log, or other document to which ready and convenient access is desirable.

The metal interior surface 410 of the metal cover 102 faces a first side 302 of the intermediate member 404, forming the first compartment 202 having a first volume. The first side 302 of the intermediate member has raised edges 205 around its periphery, defining a tray like structure that in combination with the interior surface 410 of the cover 102 forms the first compartment 202. Both the interior surface 410 of the cover 102 and the first side 302 of the intermediate member 404 are comprised of flat, smooth metal surfaces, and are coupled with the hinge mechanism 106.

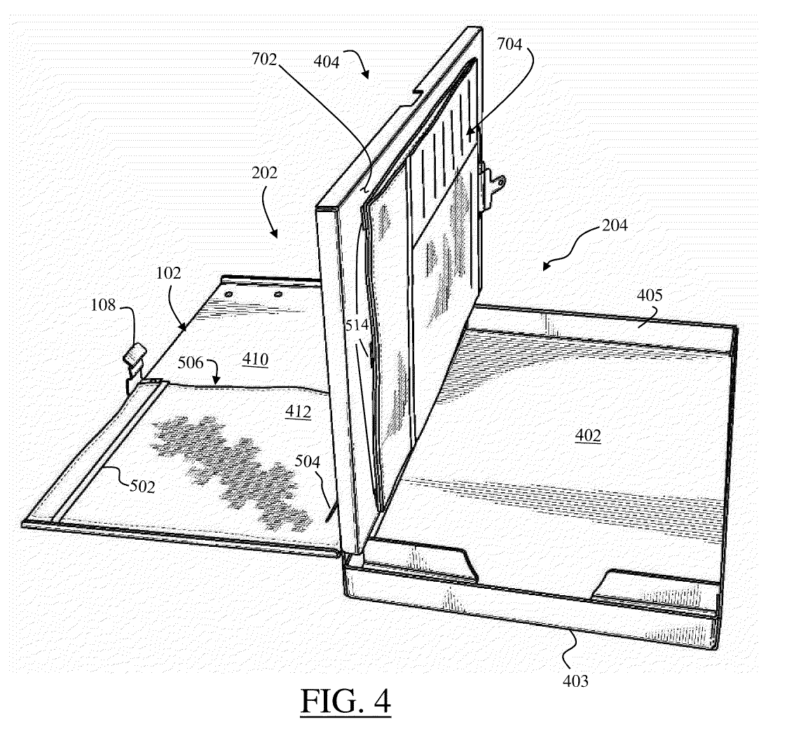

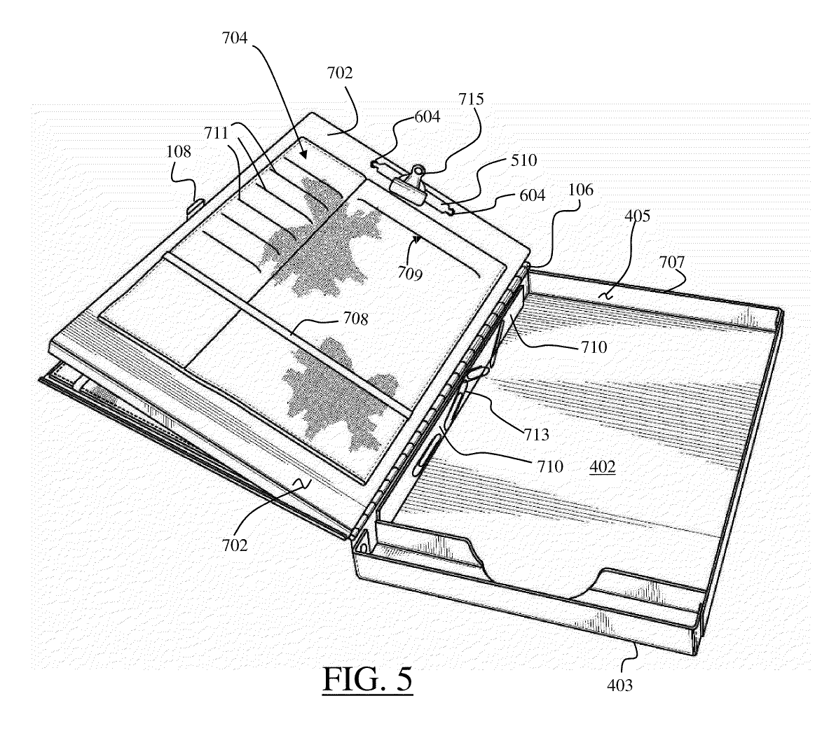

A second side 702 (FIGS. 4 and 5) of the intermediate member (or divider) 404 faces the interior 402 of the backside 403 of the portable metal document container 100, forming a second compartment 204 having a second volume. That is, the second side 702 of the intermediate member 404 faces the second compartment 204 (or the main, larger storage compartment of the portable metal document container 100). The interior 402 of the backside 403 of the portable metal document container 100 also has raised edges 405 around its periphery (similar to a deep rectangular box), defining the second compartment volume, which is greater than the first compartment volume. The second side 702 of the intermediate member 404 and the interior surface 402 of the backside 403 of the portable metal document container 100 are comprised of flat, smooth metal surfaces. Accordingly, the cover 102 encloses the first compartment 202 and the intermediate member 404 encloses the second compartment 204.

It should be noted that the cover 102, the intermediate member 404, and the backside 403 of the portable metal document container 100 of the present invention are coupled by the hinge mechanism 106, therefore, the entire unit forms a hinge connected dual storage unit. That is, the lower backside 403 of the portable metal document container 100, the intermediate member 404, and cover 102 are hinged together by a single axis hinge 106, with the hinge 106 being so constructed and configured as to pivotally position the intermediate member 404 above the lower compartment 204 (or the backside of the posse box) and to pivotally position the cover 102 above the intermediate member 404.

As illustrated in FIGS. 2, 3 and 4, the cover 102 of the portable metal document container 100 of the present invention includes an interior surface 410 that is comprised of flat, smooth metal surface, and includes a first organizer module 412 coupled with the flat, smooth metal surface by a coupler 514. Non-limiting example of coupler 514 may include a double-sided adhesive tape, one side of which is coupled with the back 413 of the first organizer module 412 and the other side coupled with the interior surface 410.

As further illustrated, the first organizer module 412 exemplarily includes (by way of non-limiting example, only) an elastic band 502 that may be used for securing an item such as a notepad, a large pocket 506 for retaining bags, envelopes or other items, and a side storage pouch with a slit opening 504 for storing yet more items. A few, non-limiting examples of items that may be stored may include envelopes, plastic baggies, cards, or any other item required by users.

As best illustrated in FIGS. 2, 4, and 5, a first side 302 of the intermediate member 404 of the portable metal document container 100 of the present invention in combination with the interior side 410 of cover 102 forms the first compartment 202 having a first volume. The first side 302 of the intermediate member 404 is comprised of raised edges 205 around the first compartment 202 periphery, defining a tray structure with a base having of flat, smooth metal surface. The intermediate member 404 further includes a set of apertures 604 along a width 112 of the portable metal document container 100, at a first center end thereof, through which are inserted a commensurate set of prongs 602 of a file-folder fastener (or document fastener) 510 for securing a plurality of labeled end-tab document dividers 300 for ready, quick, and convenient access to desired document. As illustrated, each divider may contain different form and can readily be accessed. Most commonly used forms may be stored within this compartment and organized (divided) by the labeled end-tab document dividers 300 for quick and easy access via the labeled tabs 301. Accordingly, multiple copies of different forms are organized and can be carried in an organized manner. Please note that the labeled end-tab document dividers 300 are oriented longitudinally along the length side 110 of the portable metal document container 100 so that they can fit therein. It should be noted that instead of two apertures 604 on the width side 112, one or more apertures may be made on the length side 110 of the container 100, with the labeled end-tab document dividers 300 (labels or tabs 301 facing the width side 112 or the length side 110) secured therein. In addition, a set of labeled end-tab document dividers 300 may also be used with tabs 301 that are oriented or positioned longitudinally along the length side 110 of the portable metal document container, rather than the illustrated width side 112.

As illustrated in FIGS. 4 and 5, a second side 702 of the intermediate member 404 is comprised of flat, smooth metal surface with the set of apertures 604 at the first center end, and includes a second organizer module 704 coupled with the flat, smooth metal surface by a coupler 514. Non-limiting example of coupler 514 may include a double-sided adhesive tape, one side of which is coupled to the back of the second organizer pocket 704 and the other side coupled to the surface of the second side 702.

As further illustrated, the second organizer module 704 exemplarily includes (by way of non-limiting example, only) an elastic band 708 that may be used for securing an item such as a notepad, a large sized pocket 709 for retaining booklets or other items, and a plurality of card holder pockets 711 for various cards. A few, non-limiting examples of items that may be stored may include envelopes, plastic baggies, cards, or any other item required by users. As further illustrated, the second side 702 of the intermediate member 404 in combination with the interior surface 402 of the backside 403 of the portable metal document container 100 forms the second compartment 204. The second compartment 204 has a second volume, larger than the first volume.

The backside 403 is comprised of raised edges 707 around the second compartment periphery, defining inner walls 405 of the second compartment 204 that form a second tray like structure with a base 402 of the second tray structure comprised of flat, smooth metal surface. As further illustrated, one or more inner walls of the second compartment 204 includes a magnetic strip 710, which is coupled therewith by a coupler 514. Non-limiting example of coupler 514 may include a double-sided adhesive tape, one side of which is coupled to the inner walls 406 and the other side coupled to the magnetic strip 710. As illustrated, the magnetic strip 710 is used to organize, store, and hold paper clips 713 or other metal pieces. Additional magnetic strips 710 can be used on all inner walls 405 of the second compartment 204. However, the location shown is preferred because it has a higher depth (for use of a larger magnetic strip). Of course, any part of the portable metal document container 100 may be used to couple a magnetic strip 710. It should be noted that the reason for use of a coupler 514 using an exemplary double-sided adhesive tape is because all of the surfaces of the entire portable metal document container 100 has a polymer or resin paint, and hence, even a magnetic strip 710 must use some type of a coupler mechanism 514 to couple with the polymer covered metal body of the container. It should further be noted that the magnetic clip 715 is magnetically coupled with the file-folder fastener (or document fastener) 510, which is comprised of metal.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, although not illustrated, the portable metal document container 100 of the present invention may include a first strip of soft fabric that may be coupled with a backend of the clip 104, the exterior surface of the cover, or any other appropriate location, with the first strip comprise of miniature clasps. A second, complementary strip of soft fabric comprised of miniature hooks may be coupled with an item (non-limiting examples of which may include a writing instrument or a flashlight), with the respective first and second strips forming a strip pair. The strip pair may then be aligned facing each other, and then pressed against one another, enabling the clasps of the first strip to intertwined and interlocked with the miniature hooks of the second strip to maintain the item detachably coupled with the backend of the clip or any surface of the portable metal document container 100. The strip pair are generally known by the brand name Velcro®, which is generally made of nylon fabric. Therefore, Velcro® may be used to attach items, including the organizational modules to the portable metal document container in accordance with the present invention. In addition, other mechanisms may also be used, such as rivets. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A portable metal document container, comprising:
a first organizer module that is a soft, flexible organizer pocket coupled with an interior of the portable metal document container.

2. A portable metal document container 1, wherein:
the first organizer module is coupled with an interior surface of a cover of the portable metal container.

3. A portable metal document container as set forth in claim 2, further including:
one or more magnetic strips for organizing metal objects coupled with the interior of the portable metal document container.

4. A portable metal document container as set forth in claim 3, wherein:
the one or more magnetic strips are coupled with an interior back surface of a backside of the portable metal document container.

5. The portable metal document container as set forth in claim 4, further includes:
a set of apertures through which is inserted a document fastener;
a plurality of labeled end-tab document dividers that are securely held within the interior of the portable metal document container by the document fastener, with plurality of different documents organized in between the labeled end-tab documents dividers for quick and convenient access.

6. The portable metal document container as set forth in claim 4, further including:
an intermediate member having a first side and a second side;
the intermediate member divides an interior chamber of the portable metal document container into a first and second compartments;
the first compartment is comprised of the interior surface of the cover and the first side of the intermediate member, and the second compartment is comprised of the second side of the intermediate member and a backside of the portable metal document container;
the intermediate member includes a set of apertures through which is inserted a document fastener;
a plurality of labeled end-tab document dividers are securely held on the first side of the intermediate member by the document fastener, with plurality of different documents organized in between the labeled end-tab documents dividers for quick and convenient access; and
a second organizer module is a soft, flexible organizer pocket coupled with the second side of the intermediate member.

7. A portable metal document container, comprising:
a cover having an exterior and an interior surface;
a first organizer module is a soft, flexible organizer pocket coupled with the interior surface of the cover;
an intermediate member having a first side and a second side;
the intermediate member divides an interior chamber of the posse box into a first and second compartments;
the first compartment is comprised of the interior surface of the cover and the first side of the intermediate member, and the second compartment is comprised of the second side of the intermediate member and a backside of the portable metal document container;
the intermediate member includes a set of apertures through which is inserted a document fastener;
a plurality of labeled end-tab document dividers are securely held on the first side of the intermediate member by the document fastener, with plurality of different documents organized in between the labeled end-tab documents dividers for quick and convenient access;
a second organizer module is a soft, flexible organizer pocket coupled with the second side of the intermediate member; and
an interior back surface of the backside of the posse box includes one or more magnetic strips for organizing metal objects.

8. The portable metal document container as set forth in claim 7, wherein:
the first organizer module includes:
an elastic band for securing a notepad;
a pouch, and
a side storage with a slit opening.

9. The portable metal document container as set forth in claim 7, wherein:
the first side of the intermediate member is comprised of raised edges around a periphery of the first side, defining a tray structure with a base having a flat, smooth metal surface.

10. The portable metal document container as set forth in claim 7, wherein:
the set of apertures are positioned along a width, at a first center end of the intermediate member.

11. The portable metal document container as set forth in claim 7, wherein:
the document fastener has a set of prongs that are inserted through the apertures.

12. The portable metal document container as set forth in claim 7, wherein:
the second organizer module includes:
an elastic band for securing a notepad;
a large pocket for retaining booklets, and
a plurality of smaller pockets for retaining various cards.

13. The portable metal document container as set forth in claim 7, wherein:
a coupler is used to couple:
the first organizer module with the interior surface of the cover;
the second organizer module with the second side of the intermediate member; and
the magnetic strip with the interior back surface of the backside;

14. The portable metal document container as set forth in claim 12, wherein:
the coupler is a double sided adhesive.
